(19) United States
(12) Patent Application Publication
(10) Pub. No.: US 2024/0106499 A1
(43) Pub. Date: Mar. 28, 2024

(54) COMMUNICATIONS VIA A RECONFIGURABLE INTELLIGENT SURFACE (RIS)

(71) Applicant: QUALCOMM Incorporated, San Diego, CA (US)

(72) Inventors: Saeid SAHRAEI, San Diego, CA (US); Yu ZHANG, San Diego, CA (US); Hung Dinh LY, San Diego, CA (US); Krishna Kiran MUKKAVILLI, San Diego, CA (US)

(21) Appl. No.: 18/262,966

(22) PCT Filed: Mar. 15, 2021
(86) PCT No.: PCT/CN2021/080714

§ 371 Date: Jul. 26, 2023

(51) Int. Cl. H04B 7/04; H04B 7/06; H04L 27/26; H04W 56/00; H04W 72/232

(52) U.S. Cl. CPC H04B 7/04013; H04B 7/0695; H04L 27/26025; H04W 56/0015; H04W 72/232

(57) ABSTRACT

Certain aspects of the present disclosure provide techniques for configuring a reconfigurable intelligent surface (RIS) for wireless communication. A method that may be performed by a base station (BS) includes transmitting one or more parameters corresponding to a time period for the RIS to adapt to user equipment (UE) configuration information, the UE configuration information for configuring the RIS for RIS-assisted communication between the BS and a UE, the one or more parameters comprising a number of symbols indicative of a duration of time. The method also includes transmitting, via the RIS and separately from transmitting the one or more parameters, a control channel to the UE scheduling communication of a data channel with the UE via the RIS. The method also includes communicating, via the RIS, the data channel with the UE the duration of time after transmitting the control channel to the UE.

### BACKGROUND

### Field of the Disclosure

Aspects of the present disclosure relate to wireless communications, and more particularly, to techniques for wireless communication that account for reconfiguration time for a reconfigurable intelligent surface (RIS).

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

As the demand for mobile broadband access continues to increase, there exists a need for further improvements in NR and LTE technology. These improvements should be applicable to other multi-access technologies and the telecommunication standards that employ these technologies.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include low-cost methods and techniques for extending and enhancing air interface coverage for wireless communication. For example, reconfigurable intelligent surfaces (RIS s) provide a low cost, time-efficient, and power-efficient solution for extending an air interface. Moreover, the slot structures described herein can be used to reduce down time at a RIS, thereby allowing the RIS more flexibility for other transmissions, and improving resource efficiency (e.g., less or no wasted wireless resources).

Certain aspects of the subject matter described in this disclosure can be implemented in a method for wireless communication by a base station (BS). The method generally includes transmitting one or more parameters corresponding to a time period for a reconfigurable intelligent surface (RIS) to adapt to user equipment (UE) configuration information, the UE configuration information for configuring the RIS for RIS-assisted communication between the BS and a UE, the one or more parameters comprising a number of symbols indicative of a duration of time. The method also includes transmitting, via the RIS and separately from transmitting the one or more parameters, a control channel to the UE scheduling communication of a data channel with the UE via the RIS. The method also includes communicating, via the RIS, the data channel with the UE the duration of time after transmitting the control channel to the UE.

Certain aspects of the subject matter described in this disclosure can be implemented by a BS comprising a memory and a processor coupled to the memory. The memory and the processor are configured to transmit one or more parameters corresponding to a time period for a RIS to adapt to UE configuration information, the UE configuration information for configuring the RIS for RIS-assisted communication between the BS and a UE, the one or more parameters comprising a number of symbols indicative of a duration of time. The memory and the processor are also configured to transmit, via the RIS and separately from transmitting the one or more parameters, a control channel to the UE scheduling communication of a data channel with the UE via the RIS. The memory and the processor are also configured to communicate, via the RIS, the data channel with the UE the duration of time after transmitting the control channel to the UE.

Certain aspects of the subject matter described in this disclosure can be implemented in a BS. The BS generally includes means for transmitting one or more parameters corresponding to a time period for a RIS to adapt to UE configuration information, the UE configuration information for configuring the RIS for RIS-assisted communication between the BS and a UE, the one or more parameters comprising a number of symbols indicative of a duration of time. The BS also includes means for transmitting, via the RIS and separately from transmitting the one or more parameters, a control channel to the UE scheduling communication of a data channel with the UE via the RIS. The BS also includes means for communicating, via the RIS, the data channel with the UE the duration of time after transmitting the control channel to the UE.

Certain aspects relate to a non-transitory computer-readable medium having instructions stored thereon that, when executed by a BS, cause the BS to perform operations. The operations generally include transmitting one or more parameters corresponding to a time period for a RIS to adapt to UE configuration information, the UE configuration information for configuring the RIS for RIS-assisted communication between the BS and a UE, the one or more parameters comprising a number of symbols indicative of a duration of time. The operations also include transmitting, via the RIS and separately from transmitting the one or more parameters, a control channel to the UE scheduling communication of a data channel with the UE via the RIS. The operations also include communicating, via the RIS, the data channel with the UE the duration of time after transmitting the control channel to the UE.

Certain aspects of the subject matter described in this disclosure can be implemented in a method for wireless communication by a UE. The method generally includes receiving, from a BS, one or more parameters corresponding to a time period for a RIS to adapt to UE configuration information, the UE configuration information for configuring the RIS for RIS-assisted communication between the BS and the UE, the one or more parameters comprising a number of symbols indicative of a duration of time. The method also includes receiving, from the BS, a control channel scheduling communication of a data channel with the UE via the RIS. The method also includes communicating, via the RIS, the data channel with the BS the duration of time after receiving the control channel.

Certain aspects of the subject matter described in this disclosure can be implemented by a UE comprising a memory and a processor coupled to the memory. The memory and the processor are configured to receive, from a BS, one or more parameters corresponding to a time period for a RIS to adapt to UE configuration information, the UE configuration information for configuring the RIS for RIS-assisted communication between the BS and the UE, the one or more parameters comprising a number of symbols indicative of a duration of time. The memory and the processor are configured to receive, from the BS, a control channel scheduling communication of a data channel with the UE via the RIS. The memory and the processor are configured to communicate, via the RIS, the data channel with the BS the duration of time after receiving the control channel.

Certain aspects of the subject matter described in this disclosure can be implemented in a UE. The UE may include means for receiving, from a BS, one or more parameters corresponding to a time period for a RIS to adapt to UE configuration information, the UE configuration information for configuring the RIS for RIS-assisted communication between the BS and the UE, the one or more parameters comprising a number of symbols indicative of a duration of time. The UE may include means for receiving, from the BS, a control channel scheduling communication of a data channel with the UE via the RIS. The UE may include means for communicating, via the RIS, the data channel with the BS the duration of time after receiving the control channel.

Certain aspects relate to a non-transitory computer-readable medium having instructions stored thereon that, when executed by a UE, cause the UE to perform operations. The operations generally include receiving, from a BS, one or more parameters corresponding to a time period for a RIS to adapt to UE configuration information, the UE configuration information for configuring the RIS for RIS-assisted communication between the BS and the UE, the one or more parameters comprising a number of symbols indicative of a duration of time. The operations generally include receiving, from the BS, a control channel scheduling communication of a data channel with the UE via the RIS. The operations generally include communicating, via the RIS, the data channel with the BS the duration of time after receiving the control channel.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS), a user equipment (UE), and a reconfigurable intelligent surface (RIS), in accordance with certain aspects of the present disclosure.

FIG. 3 is an example frame format for certain wireless communication systems (e.g., new radio (NR)), in accordance with certain aspects of the present disclosure.

FIG. 4 is a block diagram conceptually illustrating an example method of communication between a BS and two UEs, in accordance with certain aspects of the present disclosure.

FIG. 5 is a block diagram conceptually illustrating an example method of communication between a BS and multiple UEs via a RIS, in accordance with certain aspects of the present disclosure.

FIG. 6 is a block diagram conceptually illustrating an example method of communication between a BS and multiple UEs via multiple RIS devices arranged in different geolocations, in accordance with certain aspects of the present disclosure.

FIGS. 7A and 7B are block diagrams illustrating example slot configurations for accommodating configuration time of a RIS, in accordance with certain aspects of the present disclosure.

FIG. 8 is a call flow diagram illustrating example operations for wireless communication between a BS, a RIS, and a UE, according to certain aspects of the disclosure.

FIG. 9 is a call flow diagram illustrating example operations for wireless communication between a BS, a RIS, and a UE, according to certain aspects of the disclosure.

FIG. 10 is a flow diagram illustrating example operations for wireless communication, in accordance with certain aspects of the present disclosure.

FIG. 11 is a flow diagram illustrating example operations for wireless communication, in accordance with certain aspects of the present disclosure.

FIG. 12 is a flow diagram illustrating example operations for wireless communication, in accordance with certain aspects of the present disclosure.

FIG. 13 illustrates a communications device that may include various components (e.g., corresponding to means-plus-function components) configured to perform operations for the techniques disclosed herein, such as the operations illustrated in FIG. 10.

FIG. 14 illustrates a communications device that may include various components (e.g., corresponding to means-plus-function components) configured to perform operations for the techniques disclosed herein, such as the operations illustrated in FIG. 11.

FIG. 15 illustrates a communications device that may include various components (e.g., corresponding to means-plus-function components) configured to perform operations for the techniques disclosed herein, such as the operations illustrated in FIG. 12.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for wireless communication (e.g., transmission and/or reception of wireless signals) via a reconfigurable intelligent surface (RIS) (also known as intelligent reflecting surface (IRS), or large intelligent surfaces (LIS)).

Generally, a RIS relates to a meta-surface controlled by integrated electronic circuits that can be programmed to alter an incoming electromagnetic field in a customizable way. More specifically, the RIS may be configured with one or more planar reflecting elements that can change the phase of a signal incident thereon without changing the amplitude of the incident signal. In some examples, a RIS may include an array of reflecting elements, wherein each of the reflecting elements of the array are characterized by an electronically controlled resonant frequency. The reflecting elements may operate on an incoming field in continuity or in discrete positions. For example, the array of reflecting elements of a RIS may be configured as a single group to reflect a specific beam of an uplink or downlink transmission, or the elements may be configured into discrete groups to assist in multiple-input multiple-output (MIMO) communications.

The array of reflecting elements may be constructed of a metamaterial having physical properties (e.g., permittivity and permeability) engineered to perform a transformation on electromagnetic fields reflected from the RIS. In general, metamaterials are artificially engineered micro/nanostructures that, at given frequencies, show negative permeability and permittivity. Metamaterials applied on a surface (e.g., a reflecting element of a RIS) can be applied by arranging electrically small scatterers or holes into a two-dimensional pattern on a surface. Such a metamaterial surface may be referred to herein as a meta-surface.

In some examples, a RIS may behave like a passive metal mirror or wave modulator, and may be programmed to alter or change an incident wireless signal in a customizable way. As descried herein, the altered or changed signal may be referred to as a “reflection.” In this example, the RIS may be constructed primarily of passive reflecting elements that do not require dedicated power sources (e.g., power amplifiers). Thus, the RIS may be a substantially passive device configured to forward or “reflect” incoming wireless beams or signals in a particular direction. Accordingly, the RIS provides a low-energy alternative to active antenna elements for increasing wireless communication throughput in MIMO communications.

As such, the RIS may be configured to directionally reflect incident wireless signals by adjusting a phase shift at each of the array of reflecting elements, thereby allowing for signal propagation by phase shift modifications to one or more reflecting elements.

Changes may be made to aspects of the following description in the function and arrangement of elements discussed without departing from the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

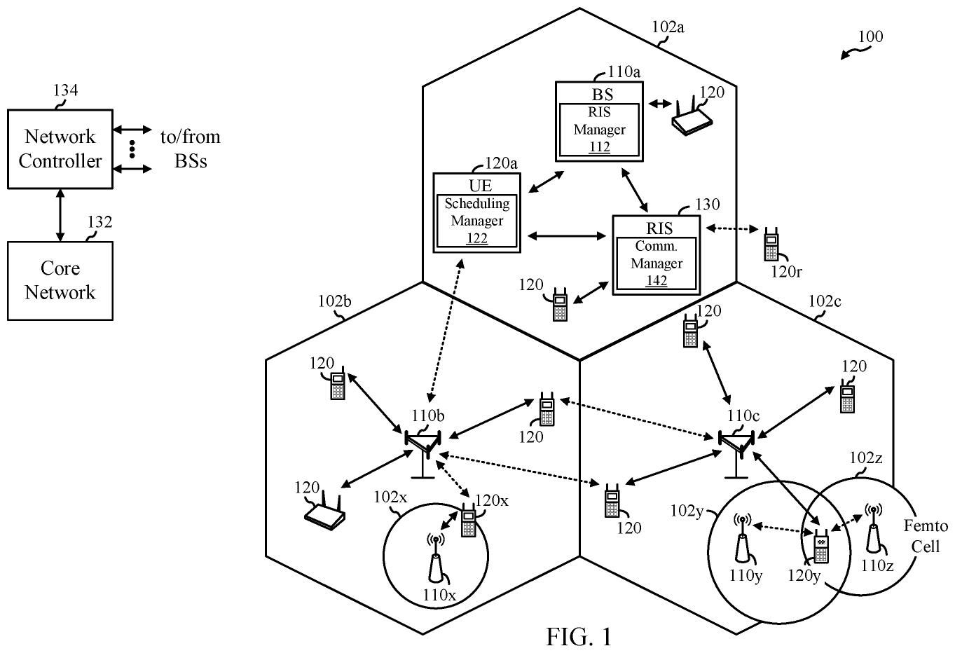

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110a-z (each also individually referred to herein as BS 110 or collectively as BSs 110) and/or user equipment (UE) 120a-y (each also individually referred to herein as UE 120 or collectively as UEs 120) in the wireless communication network 100 via one or more interfaces.

According to certain aspects, the BS 110a, UE 120a, and RIS 130 may be configured for wireless communication techniques that account for slot structure configurations. As shown in FIG. 1, the BS 110a includes a RIS manager 112 that may be configured for transmitting one or more parameters corresponding to a time period for the RIS 130 to adapt to UE configuration information. The UE configuration information may be information for configuring the RIS 130 for RIS-assisted communication between the BS 110a and the UE 120a. In some examples, the one or more parameters include a number of symbols indicative of a duration of time. The RIS manager 112 may also be configured for transmitting, via the RIS 130 and separately from transmitting the one or more parameters, a control channel to the UE 120a scheduling communication of a data channel with the UE 120a via the RIS 130. The RIS manager 112 may also be configured for communicating, via the RIS 130, the data channel with the UE 120a the duration of time after transmitting the control channel to the UE 120a, in accordance with aspects of the present disclosure.

The UE 120a includes a scheduling manager 122 that may be configured for receiving, from BS the 110a, one or more parameters corresponding to a time period for the RIS 130 to adapt to UE configuration information. In some examples, the UE configuration information includes information for configuring the RIS 130 for RIS-assisted communication between the BS 110a and the UE 120a. In some examples, the one or more parameters include a number of symbols indicative of a duration of time. The scheduling manager 122 may also be configured for receiving, from the BS 110a, a control channel scheduling communication of a data channel with the UE 120a via the RIS 130. The scheduling manager 122 may also be configured for communicating, via the RIS 130, the data channel with the BS 110a the duration of time after receiving the control channel, in accordance with aspects of the present disclosure.

The RIS 130 includes a communication manager 142 that may be configured for receiving, from BS 110a, a control channel comprising UE configuration information, the UE configuration information for configuring the RIS 130 for RIS-assisted communication between the BS 110a and the UE 120a, wherein the control channel is formatted according to a first format. The communication manager 142 may also be configured for determining that the control channel is formatted according to the first format. The communication manager 142 may also be configured for refraining from providing the control channel to the UE 120a based on the determination that the control channel is formatted according to the first format. In certain aspects, the communication manager 142 comprises a controller coupled to the RIS 130. In certain aspects, communication between the controller and the BS 110a is via a wired interface. In certain aspects, communication between the controller and the BS 110a is via a wireless interface.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other B Ss or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., active antenna unit relay station, RIS 130, etc.), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 134 may be in communication with a set of BSs 110 and provide coordination and control for these BSs 110 (e.g., via a backhaul). In aspects, the network controller 134 may be in communication with a core network 132 (e.g., a 5G Core Network (5GC)), which provides various network functions such as access and mobility management function (AMF), session management, user plane function (UPF), policy control function, authentication server function, unified data management (ADM), application function, network exposure function, network repository function, network slice selection function, etc.

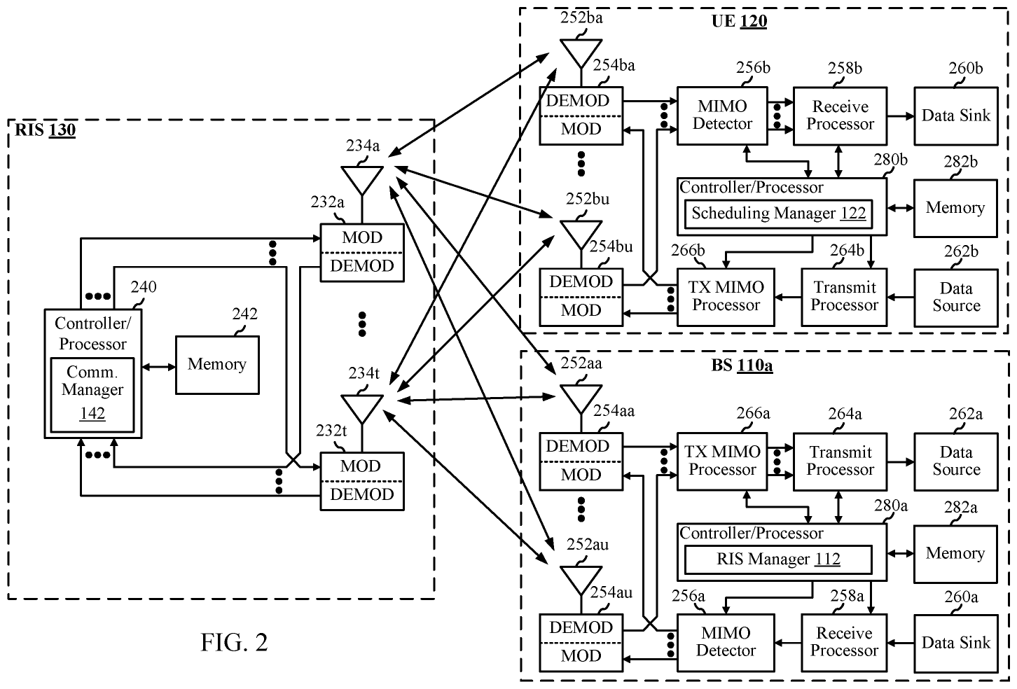

FIG. 2 is a block diagram illustrating example components of a RIS 130, a BS 110a, and a UE 120 (e.g., UE 120a, UE 120r, UE 120) in a wireless communication network (e.g., wireless communication network 100 of FIG. 1), which may be used to implement aspects of the present disclosure. In some aspects of the disclosure, devices such as the BS 110a, RIS 130, and/or UE 120 may be configured for beamforming and/or MIMO technology. The use of such multiple antenna technology enables the wireless communication system to exploit the spatial domain to support spatial multiplexing, beamforming, and transmit diversity.

At the BS 110a, a transmit processor 264a may receive data from a data source 262a and control information from a controller/processor 280a. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The transmit processor 264a may process (e.g., encode and symbol map) the data and control information to obtain data symbols and control symbols, respectively. The transmit processor 264a may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 266a may perform spatial processing (e.g., precoding) on the data symbols, the control symbols, and/or the reference symbols, if applicable, and may provide output symbol streams to the modulators (MODs) in transceivers 254aa-254au. Each modulator in the transceivers 254aa-254au may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from the modulators may be transmitted via the antennas 252aa-252au, respectively.

At the UE 120, the antennas 252ba-252bu may receive the downlink signals from the BS 110a via the RIS 130, and may provide received signals to the demodulators (DEMODs) in transceivers 254ba-254bu, respectively. Each demodulator may condition (e.g., filter, amplify, downconvert, and digitize) a respective received signal to obtain input samples. Each demodulator may further process the input samples (e.g., for OFDM, etc.) to obtain received symbols. A MIMO detector 256b may obtain received symbols from all the demodulators, perform MIMO detection on the received symbols if applicable, and provide detected symbols. A receive processor 258b may process (e.g., demodulate, deinterleave, and decode) the detected symbols, provide decoded data for the UE 120 to a data sink 260b, and provide decoded control information to a controller/processor 280b.

On the uplink, at UE 120, a transmit processor 264b may receive and process data (e.g., for the physical uplink shared channel (PUSCH)) from a data source 262b and control information (e.g., for the physical uplink control channel (PUCCH)) from the controller/processor 280b. The transmit processor 264b may also generate reference symbols for a reference signal (e.g., for the sounding reference signal (SRS)). The symbols from the transmit processor 264b may be precoded by a TX MIMO processor 266b if applicable, further processed by the modulators in transceivers 254ba-254bu (e.g., for SC-FDM, etc.), and transmitted to the BS 110a. At the BS 110a, the uplink signals from the UE 120a may be received by one or more antennas 252aa-252au, processed by one or more demodulators in transceivers 254aa-254au, detected by a MIMO detector 256a if applicable, and further processed by a receive processor 258a to obtain decoded data and control information sent by the UE 120. The receive processor 258a may provide the decoded data to a data sink 260a and the decoded control information to the controller/processor 280a.

The memories 282a/282b may store data and program codes for BS 110a and UE 120, respectively. A scheduler (not shown) at the BS 110a may schedule UEs for data transmission on the downlink and/or uplink.

At the RIS 130, antennas 234a-234t may receive downlink signals from the BS 110a and may provide received signals to transceivers 232a-232t that include modulators for signal modulation and demodulation. Each modulator may condition (e.g., apply a phase shift to directionally reflect a received signal) a respective received signal. Each modulator may further process the received signals (e.g., digitize the received signal) and provide the processed signals to a controller/processor 240. The RIS 130 may include a memory 242 configured to temporarily store modulation configurations and corresponding time slots provided by the BS 110a.

Antennas 252ba, processors 266b, 258b, 264b, and/or controller/processor 280b of the UE 120 may be used to perform the various techniques and methods described herein. For example, as shown in FIG. 2, the controller/processor 280b of the UE 120 has a scheduling manager 122 configured to receive, from the BS 110a, one or more parameters corresponding to a time period for the RIS 130 to adapt to UE configuration information. The UE configuration information may be used for configuring the RIS 130 for RIS-assisted communication between the BS 110a and the UE 120. The one or more parameters may include a number of symbols indicative of a duration of time. The scheduling manager 122 may also be configured to receive, from the BS 110a, a control channel scheduling communication of a data channel with the UE 120 via the RIS. The scheduling manager 122 may also be configured to communicate, via the RIS, the data channel with the BS 110a the duration of time after receiving the control channel.

Antennas 252aa, processors 266a, 258a, 264a, and/or controller/processor 280a of the BS 110a may be used to perform the various techniques and methods described herein. For example, as shown in FIG. 2, the controller/processor 280a of the BS 110a has a RIS manager 112 configured for transmitting one or more parameters corresponding to a time period for the RIS 130 to adapt to UE configuration information, the UE configuration information for configuring the RIS 130 for RIS-assisted communication between the BS 110a and the UE 120, the one or more parameters comprising a number of symbols indicative of a duration of time. The RIS manager 112 may also be configured for transmitting, via the RIS 130 and separate from transmitting the one or more parameters, a control channel to the UE 120 scheduling communication of a data channel with the UE 120 via the RIS 130. The RIS manager 112 may also be configured for communicating, via the RIS 130, the data channel with the UE 120 the duration of time after transmitting the control channel to the UE 120.

Antennas 234a-234t and controller/processor 240 of the RIS 130 may be used to perform the various techniques and methods described herein. For example, as shown in FIG. 2, the controller/processor 240 of the RIS 130 has a communication manager 142 configured to receive, from the BS 110a, a control channel comprising UE configuration information, the UE configuration information for configuring the RIS 130 for RIS-assisted communication between the BS 110a and the UE 120, the control channel formatted according to a first format. The communication manager 142 may also be configured to determine that the control channel is formatted according to the first format. The communication manager 142 may also be configured to refrain from providing the control channel to the UE 120 based on the determination that the control channel is formatted according to the first format.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

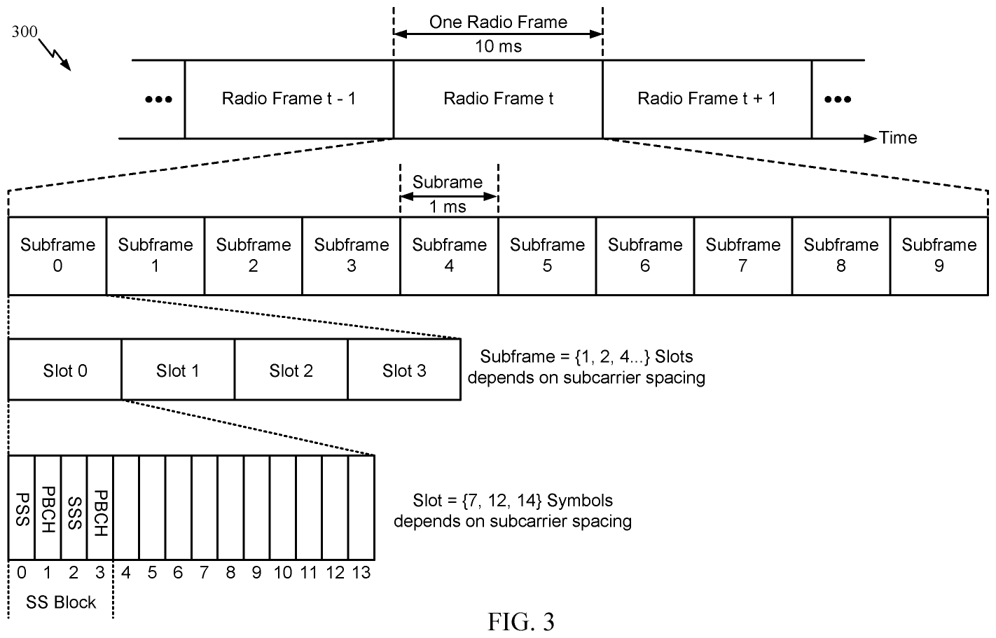

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure may refer to a transmit time interval having a duration less than a slot (e.g., 2, 3, or 4 symbols). Each symbol in a slot may be configured for a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIB s), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

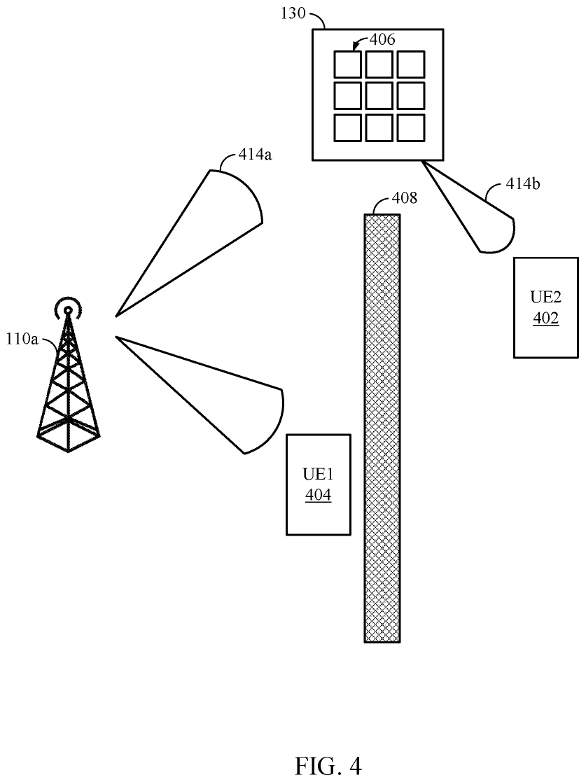

FIG. 4 is a block diagram conceptually illustrating an example method of communication between a BS and two UEs, in accordance with certain aspects of the present disclosure. In this example, a BS 110a is in communication with a first UE 404 and a second UE 402 (e.g., any one or more of UE 120, UE 120r, UE 120a of FIG. 1). However, in this example, a blockage 408 prevents the BS 110a from having a clear line of sight to the second UE 402 for wireless communication.

Accordingly, the RIS 130 may be utilized to extend wireless communication between the BS 110a and the second UE 402 so that the blockage 408 no longer prevents communication. Here, the BS 110a transmits a first signal 414a (e.g., in a directional beam) to the RIS 130. The RIS 130 can then use phase shifting at the surface of the RIS 130 to generate a reflected signal 414b in a particular direction. In this example, the reflected signal 414b is a directional reflection of the first signal 414a produced by the RIS 130.

As discussed, the RIS 130 may include a plurality of passive reflective elements 406 arranged as an array. In some examples, the entire array of reflective elements 406 may be utilized to communicate with a single UE. Alternatively, the reflective elements 406 may be partitioned into several subsets, with each subset serving a different UE. In this example, the RIS 130 may be capable of serving more than one UE and/or BS, and reconfiguration of the RIS 130 (by the BS 110a and/or the UE 120a) may be simplified when new UEs join the network.

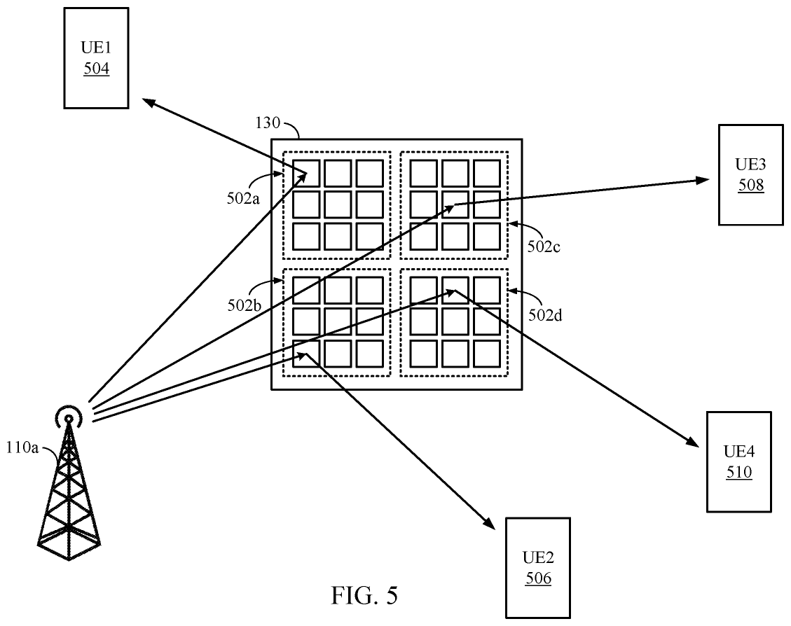

FIG. 5 is a block diagram conceptually illustrating an example method of communication between a BS 110a and multiple UEs (e.g., UEs 504-510) via a RIS 130, in accordance with certain aspects of the present disclosure. In this example, the RIS 130 includes an array of reflective elements partitioned into four separate groups: a first group 502a, a second group 502b, a third group 502c, and a fourth group 502d. It should be noted that while each of the partitioned groups are illustrated as comprising adjacent sets of reflective elements, each group of reflective elements may alternatively be comprised of one or more reflective elements that are not adjacent to another one or more reflective elements of the same group.

In this example, the BS 110a and RIS 130 support beamforming with MIMO antenna technology. That is, the partitioned groups of reflective elements of the RIS 130 may be configured to assist in MIMO communications. Here, each of the partitioned groups supports a different UE.

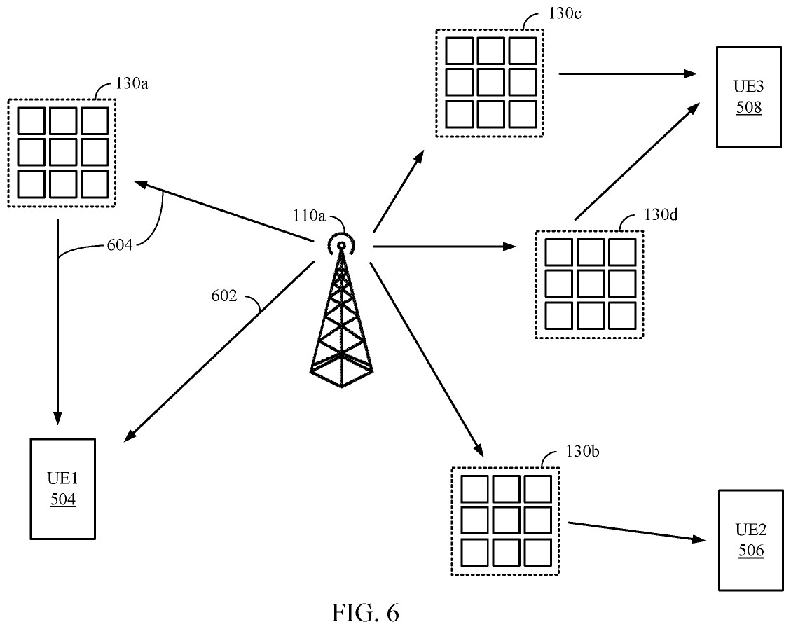

FIG. 6 is a block diagram conceptually illustrating an example method of communication between a BS 110a and multiple UEs (e.g., UEs 504-508) via multiple RIS devices (130a-130d) arranged in different geolocations, in accordance with certain aspects of the present disclosure. In this example, the BS 110a communicates with a first UE 504 via two paths: a direct path 602, and also an indirect path 604 via a first RIS 130a. The BS 110a also communicates with a second UE 506 via an indirect path through a second RIS 130b, and with a third UE 508 via two indirect paths through a third RIS 130c and a fourth RIS 130d.

As illustrated, multiple RIS devices may be geographically separated throughout, for example, a construction yard or an office building. Each of the distributed RIS devices may be a smaller version of a standard RIS, for example, having relatively fewer reflective elements and only being able to support a limited number of UEs. In such an arrangement, spatial diversity may be expanded to allow a single BS 110a the ability to communicate with multiple distributed UEs in situations where blockages would otherwise prevent communication with one or more of the UEs.

### Example Techniques for Configuring a RIS and Communicating Via the RIS

Aspects of the present disclosure provide slot structure considerations for RIS-assisted downlink transmissions. In some examples, the BS 110a may transmit UE configuration information to the RIS 130 to prepare the RIS 130 for relaying signaling between the BS 110a and a UE 120. For example, the UE configuration information may provide the RIS 130 with an indication of a phase shift required for the RIS 130 to reflect downlink signaling to the UE 120. In this example, the BS 110a may transmit the configuration information to the RIS 130 via a control channel (e.g., PDCCH).

However, once the RIS 130 configures itself for communication based on the configuration information (e.g., once the RIS 130 is configured to reflect received signals toward a particular UE), there may be a significant delay between the RIS 130 completing its configuration, and the RIS 130 reflecting a received signal toward the particular UE 120. That is, the RIS 130 may be idle while pointing at a particular UE 120 and waiting for a signal to reflect. Accordingly, it would be beneficial to reduce any downtime between the RIS 130 completing its configuration, and receiving signaling to reflect to a UE 120 so that the RIS 130 has more flexibility for reconfigurations and communications with other UEs.

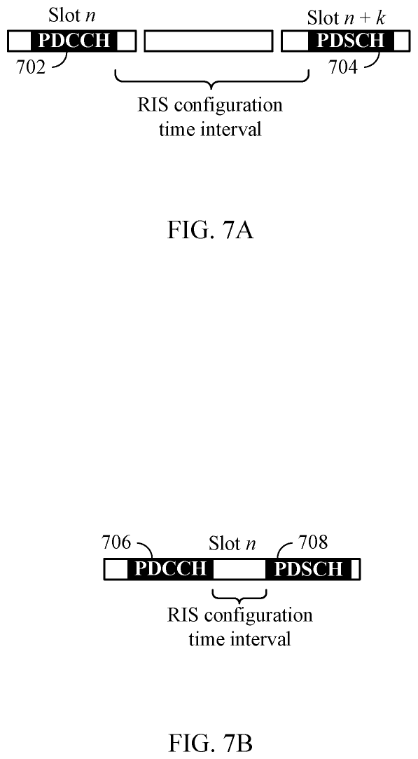

FIGS. 7A and 7B are block diagrams illustrating example slot configurations for accommodating configuration time of a RIS. Though certain aspects are discussed with respect to time periods in terms of “slots,” it should be noted that the techniques discussed may be applied to other suitable time periods used. First, FIG. 7A illustrates a first slot (slot n) within which a PDCCH 702 is communicated from a BS 110a to a RIS 130. In this example, the PDCCH 702 includes UE configuration information that the RIS 130 can use to configure a phase angle of one or more of its reflective elements so that the RIS 130 can reflect signals received from the BS 110a to a UE 120. Upon receiving the PDCCH 702, the RIS 130 decodes the PDCCH 702 and configures the phase angle of the one or more of its reflective elements according to the UE configuration information. In this example, the RIS 130 has a RIS configuration time interval, or “gap time,” amounting to more than 1 slot to configure itself according to the UE configuration information. The BS 110a may then transmit a PDSCH 704 containing data directed to the UE 120a in a second slot (slot n+k, wherein k is a number of slots after slot n). In certain aspects, k is equal to the number of slots or symbols that define the temporal duration of the gap time. That is, the BS 110a may first transmit a PDCCH that configures the RIS 130, then after providing the RIS 130 with enough time (e.g., gap time) to configure its reflective elements, the BS 110a may proceed to transmit a PDSCH with the expectation that the RIS 130 reflect the PDSCH according to the configuration information of the PDCCH.

Similarly, FIG. 7B illustrates a third slot (slot n) that contains both of: (i) a PDCCH 706 that contains the UE configuration information, and (ii) a PDSCH 708 containing data directed to the UE 120a. In this example, the gap time for configuring the RIS 130 is less than 1 slot. It should be noted that the gap time difference between FIGS. 7A and 7B may be due to RIS 130 size (e.g., the number of reflective elements used by the RIS 130) and/or any other factors that may affect a RIS 130 response time. Gap times may also be larger or smaller relative to the size of a slot based on the subcarrier spacing (SCS) used by the BS 110a. In some examples, because a BS 110a may use a plurality of different SCSs in its communication with UEs (e.g., different SC Ss used during and after initial connection process), a BS 110a may notify a UE 120 of the gap time in terms of a number of symbols.

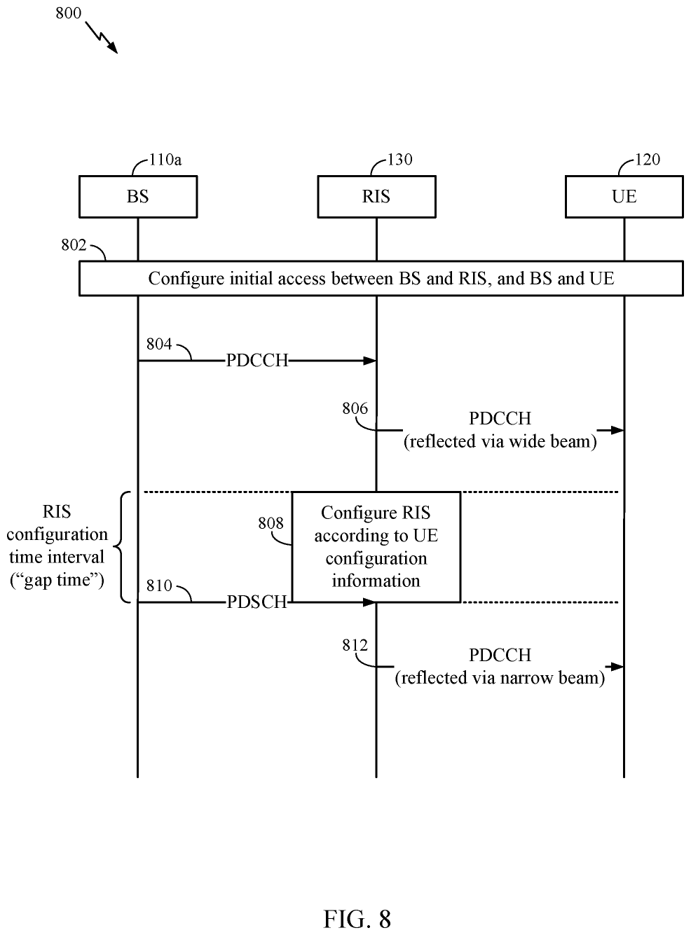

FIG. 8 is a call flow diagram 800 illustrating example operations for wireless communication between a BS, a RIS, and a UE (e.g., BS 110a, RIS 130, and UE 120a of FIG. 1, respectively), according to certain aspects of the disclosure.

Initially, the BS 110a may establish initial access with the RIS 130 at a first block 802. During initial access, the BS 110a may configure the RIS 130 with phase angles for receive beams and transmit beams for communication between the BS 110a and the UE 120. Thus, initial downlink transmissions that are reflected by the RIS 130 to the UE 120 may be reflected over a relatively wide beam.

During initial access, the BS 110a may also determine a RIS configuration time interval, or “gap time.” That is, the BS 110a may determine an amount of time required by the RIS 130 to adapt its reflective elements to a particular phase angle provided by the BS 110a. In one example, the BS 110a may determine the gap time by configuring the RIS 130 with a first phase angle directed away from the BS 110a, then configuring the RIS 130 with a phase angle directed to the BS 110a and timing how long it takes for the RIS 130 to reflect a continuously transmitted signal from the BS 110a back to the BS 110a.

The BS 110a may also establish initial access with the UE 120 at the first block 802. During initial access, the BS 110a may provide the UE 120 with an indication of the gap time. For example, the BS 110a may communicate the indication to the UE 120 via a system information message (e.g., master information block (MIB), system information block (SIB), other system information (OSI), or any other suitable system information message). In certain aspects, the indication of the gap time may be a provided to the UE 120 in the resolution of symbols (e.g., a number of symbols) or as a function of a number of symbols. However, as discussed, the time duration of the number of symbols is relative to the subcarrier spacing (SCS) used to determine the gap time. Thus, the UE 120 needs to have an SCS point of reference in order to compute the gap time from the number of symbols it receives in the system information message.

In a first option, the reference SCS for computing the gap time is the same SCS used by the BS 110a for transmitting a PDCCH associated with a first communication 804, discussed below in more detail. That is, the UE 120 can calculate the gap time based on the number of symbols indicated by the BS in the system information message and based on the SCS of the PDCCH that schedules a downlink data communication. In a second option, the reference SCS is the same SCS that the BS 110a used to determine the gap time (e.g., 15 kHz). In a third option, the reference SCS may be explicitly signaled to the UE 120 in the system information message that carries the indication of the gap time.

In some examples, the system information message that carries the indication of the gap time may also carry an indication of which of the above three options is being used to provide the UE 120 with the reference SCS. For example, if the first option is used, a flag (e.g., a bit), a reference signal (RS) pattern, etc., may indicate that the UE 120 is to calculate the gap time based on the SCS used for transmitting the PDCCH. If the second or third options are used, then the system information message may explicitly indicate the reference SCS. Accordingly, the reference SCS and the gap time may be communicated to the UE 120a once during initial access instead of multiple times after initial access and before/with each downlink grant.

In certain aspects, the indication of the gap time is also configured to indicate whether the RIS 130 is part of the network. For example, if the RIS 130 is not part of the communication path between the BS 110a and the UE 120, then the system information message may omit any indication of a gap time. That is, the system information message may omit an indication of the number of symbols that defines the gap time, a reference SCS, and/or an indication of which of the three options is used for identifying the reference SCS.

At a first communication 804, the BS 110a transmits a PDCCH message to the RIS 130. In this example, the PDCCH contains both of: (i) UE configuration information, and (ii) downlink grant information scheduling a downlink data transmission via PDSCH. In some examples, the UE configuration information includes a phase angle for one or more reflective elements of the RIS 130. The phase angle may be used by the RIS 130 to adjust the previously configured wide beam to a relatively narrower beam directed to the UE 120. Thus, the RIS 130 may receive the PDCCH and decode the UE configuration information, and adjust the phase angle of the one or more reflective elements accordingly. In certain aspects, the UE configuration information also includes an indication of which of the reflective elements the RIS 130 is to adjust. For example, the indication may identify a group of reflective elements from a plurality of groups configured by the BS 110a during initial access.

Moreover, because the RIS 130 is already configured with the wide beam directed to the UE 120, the RIS 130 may reflect the PDCCH via the wide beam to the UE 120 in a second communication 806. Here, the UE 120 is able to receive the PDCCH and decode the downlink grant information to determine when it can expect to receive the downlink data transmission. As discussed, the BS 110a will schedule the downlink data transmission to occur after the gap time has elapsed (e.g., once the RIS 130 has had enough time to apply the phase angle adjustment provided in the UE configuration information). As noted earlier, this provides the benefit of reducing idle time at the RIS 130. For example, if the RIS 130 is configured for a particular UE, that RIS 130 generally may not be able to support communications between the BS 110a and another UE. Thus, the reduced time between a PDCCH transmission and a PDSCH provides greater flexibility for scheduling downlink transmissions to other UEs.

Once the RIS 130 receives the PDCCH and determines the phase angle(s) it is to apply, it begins to configure the reflective elements according to the determined phase angles at a second block 808. This RIS configuration may generally take the amount of time provided by the determined gap time to complete. In some examples, the RIS 130 may be able to configure its reflective elements within the duration of a cyclic prefix (CP).

In a third communication 810 at the end of the gap time interval, the BS 110a may transmit downlink data to the UE 120 via the RIS 130. The BS 110a may assume that the RIS 130 has completed configuration of its reflective elements during the duration of the gap time. In some examples, configuration of the reflective elements results in the RIS 130 reflecting a received signal via a narrower, directed beam according to the phase angle(s) it receives from the BS 110a. Thus, in a fourth communication 812, the RIS 130 may reflect the signal (e.g., PDSCH) received from the BS 110a to the US 120 via a beam that is relatively narrower than the wide beam previously used by the RIS 130 in the second communication 806.

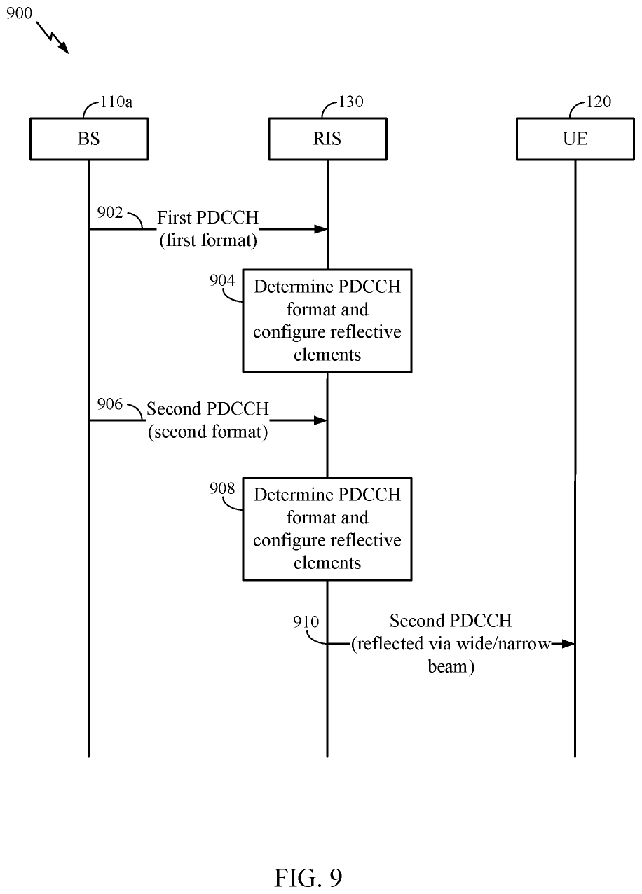

FIG. 9 is a call flow diagram 900 illustrating example operations for wireless communication between a BS, a RIS, and a UE (e.g., BS 110a, RIS 130, and UE 120a of FIG. 1, respectively), according to certain aspects of the disclosure. One or more of the functions and communications illustrated in FIG. 9 may be performed during the initial access in the first block 802 of FIG. 8.

In certain aspects, the BS 110a may use two separate PDCCH formats for communicating data to the RIS 130 and the UE 120. For example, the BS 110a may use a first format to configure the RIS 130 for communications between the BS 110a and the UE 120, and a second format for scheduling a downlink data transmission with the UE 120. In some examples, the first PDCCH format is a downlink control information (DCI) format 1 message, and the second PDCCH format is a DCI format 2 message.

As illustrated in the example of FIG. 9, the BS 110a may initiate configuration of the RIS 130 by communicating a first PDCCH containing a DCI format 1 message to the RIS 130 in a first communication 902. Such a configuration may take place during, for example, initial access illustrated in the first block 802 of FIG. 8. Here, the BS 110a may include phase angle information in the DCI format 1 message to configure the RIS 130 for wide beam reflection of signaling to the UE 120. In some examples, the BS 110a may transmit multiple DCI format 1 messages to the RIS 130 to establish a proper configuration.

At a first block 904, the RIS 130 receives and decodes the first PDCCH and determines that the first PDCCH contains a DCI format 1 message. The RIS 130 also begins to configure its reflective elements according to the phase angle information provided in the DCI. Based on the determination that the first PDCCH contains a DCI format 1 message, the RIS 130 may determine that the UE 120 does not require the first PDCCH, or that the first PDCCH does not contain any information that the UE 120 can use. Thus, the RIS 130 may determine not to reflect the first PDCCH to the UE 120. Alternatively, the RIS 130 may reflect the first PDCCH in a direction that is directed substantially away from the UE 120. Alternatively, the first PDCCH may include a radio network temporary identifier (RNTI) that the BS 110a randomly generates and inserts into the DCI. In this example, the RIS 130 may transmit the first PDCCH to the UE 120 because the UE 120 would not recognize the RNTI, and thus, would not try to decode the first PDCCH.

The BS 110a may then transmit a second PDCCH containing a DCI format 2 message to the RIS 130 in a second communication 906. The DCI format 2 message is a different format than the DCI format 1 message. The DCI format 2 message may serve two purposes: (i) enhancing the configuration of the RIS 130, and/or (ii) providing control information to the UE 120. For example, the BS 110a may include phase angle information in the DCI format 2 message for narrowing and refining the direction of the relatively wider beams used by the RIS 130 as configured by the DCI format 1 message. The BS 110a may also include an indication of the gap time in the DCI format 2 message that the UE 120 can use as a downlink grant to determine scheduling for a downlink data communication. The BS 110a may also include an indication of scheduling for any uplink transmissions from the UE 120 to the BS 110a via the RIS 130.

At a second block 908, the RIS 130 receives and decodes the second PDCCH and determines that the second PDCCH contains a DCI format 2 message. If the DCI format 2 message includes an indication of a phase angle change, the RIS 130 may also begin to configure its reflective elements according to the indication. Based on the determination that the second PDCCH contains a DCI format 2 message, the RIS 130 may forward (e.g., reflect) the second PDCCH to the UE 120 in a third communication 910. It should be noted that the second PDCCH may be reflected to the UE 120 using either of a wide beam or a narrow beam. For example, the BS 110a may not have completed configuration of a narrow beam for the RIS 130.

The UE 120 receives second PDCCH as reflected by the RIS 130 in the third communication 910. As discussed above in reference to FIG. 8, the UE 120 may decode the second PDCCH to determine the gap time which it can use to determine a scheduled downlink data communication from the BS 110a via the RIS 130.

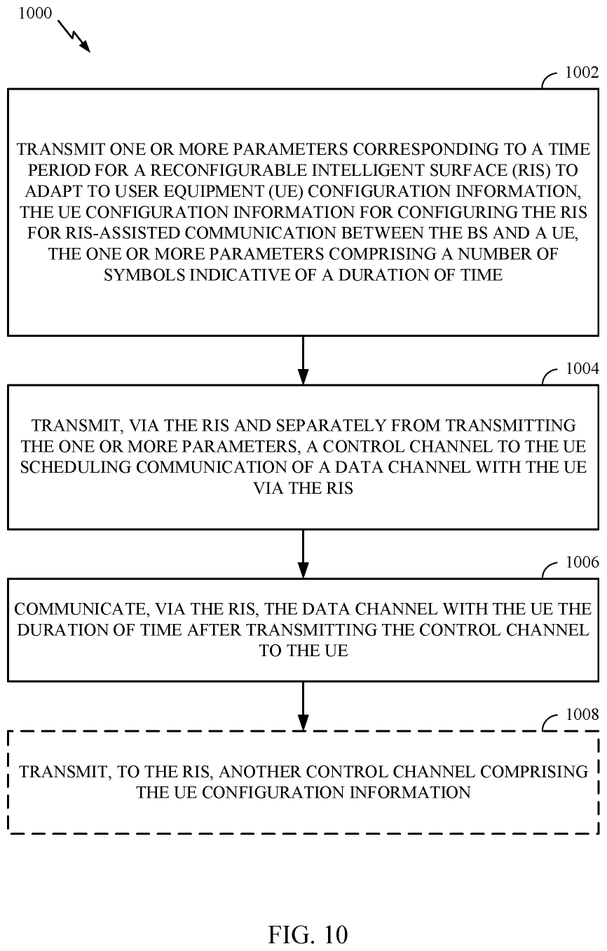

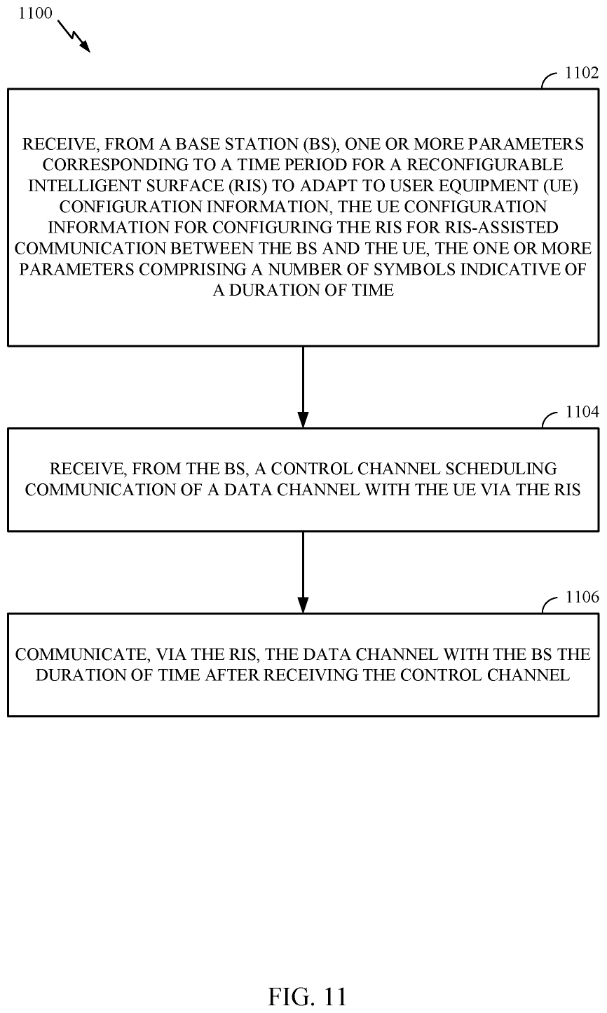

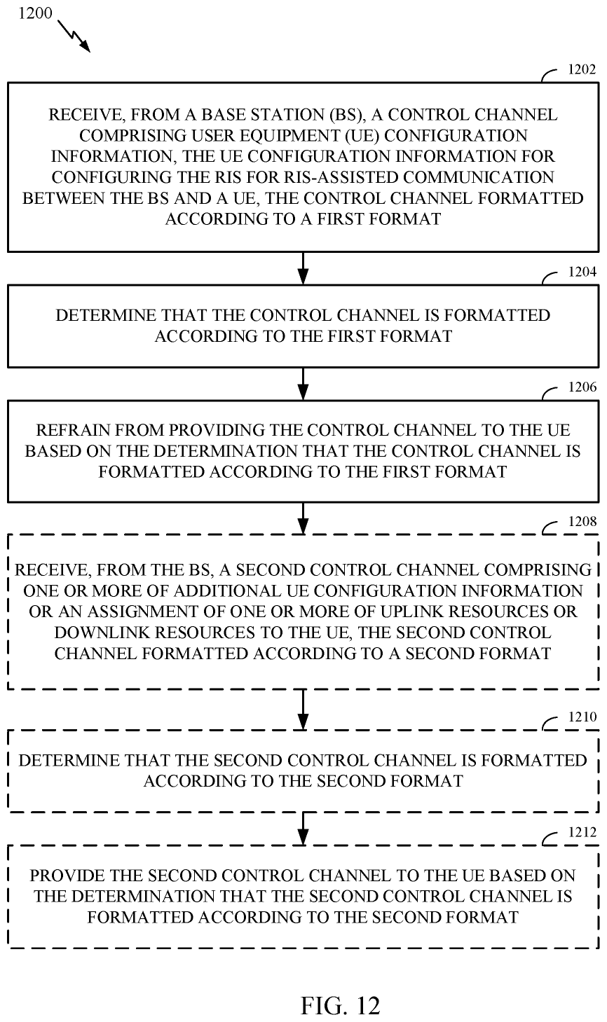

FIG. 10 is a flow diagram illustrating example operations 1000 for wireless communication, in accordance with certain aspects of the present disclosure. The operations 1000 may be performed, for example, by a BS (e.g., such as the BS 110a in the wireless communication network 100 of FIG. 1). The operations 1000 may be complementary to the operations 1100 of FIG. 11 performed by a UE, and operations 1200 of FIG. 12 performed by a RIS. The operations 1000 may be implemented as software components that are executed and run on one or more processors (e.g., controller/processor 280a of FIG. 2). Further, the transmission and reception of signals by the BS in operations 1000 may be enabled, for example, by one or more antennas (e.g., antennas 252aa-252au of FIG. 2). In certain aspects, the transmission and/or reception of signals by the BS may be implemented via a bus interface of one or more processors (e.g., controller/processor 280a) obtaining and/or outputting signals.

The operations 1000 may begin, at a first block 1002, by transmitting one or more parameters corresponding to a time period for a reconfigurable intelligent surface (RIS) to adapt to user equipment (UE) configuration information, the UE configuration information for configuring the RIS for RIS-assisted communication between the BS and a UE, the one or more parameters comprising a number of symbols indicative of a duration of time.

The operations 1000 may proceed at a second block 1004 by transmitting, via the RIS and separately from transmitting the one or more parameters, a control channel to the UE scheduling communication of a data channel with the UE via the RIS

The operations 1000 may proceed at a third block 1006 by communicating, via the RIS, the data channel with the UE the duration of time after transmitting the control channel to the UE.

Optionally, the operations 1000 may proceed at a fourth block 1008 by transmitting, to the RIS, another control channel comprising the UE configuration information.

In certain aspects, the UE configuration information comprises a phase shift parameter configured to adjust a phase of one or more reflective elements of the RIS.

In certain aspects, transmitting the one or more parameters comprises broadcasting the one or more parameters as system information via a synchronization signal block (SSB).

In certain aspects, the one or more parameters further comprise an indication of a reference subcarrier spacing (SCS) corresponding to the number of symbols.

In certain aspects, the indication of the reference SCS comprises one of: an indication that the reference SCS is the same as an SCS used for transmission of the control channel; an indication that the reference SCS is a fixed SCS; or an explicit indication of a frequency of the reference SCS.

In certain aspects, the control channel and the data channel are both transmitted within a first slot.

In certain aspects, the control channel comprises the UE configuration information.

In certain aspects, the control channel further comprises additional UE configuration information.

In certain aspects, the control channel comprises a first downlink control information (DCI) message formatted according to a first DCI format and comprising a first radio network temporary identifier (RNTI), and wherein the other control channel comprises a second DCI message formatted according to a second DCI format and comprising a second RNTI, the second RNTI corresponding to the UE and the first RNTI not corresponding to the UE.

FIG. 11 is a flow diagram illustrating example operations 1100 for wireless communication, in accordance with certain aspects of the present disclosure. The operations 1100 may be performed, for example, by a UE (e.g., such as the UE 120a in the wireless communication network 100 of FIG. 1). The operations 1100 may be complementary to the operations 1000 of FIG. 10 performed by a BS, and operations 1200 of FIG. 12 performed by a RIS. The operations 1100 may be implemented as software components that are executed and run on one or more processors (e.g., controller/processor 280b of FIG. 2). Further, the transmission and reception of signals by the UE in operations 1100 may be enabled, for example, by one or more antennas (e.g., antennas 252ba-252bu of FIG. 2). In certain aspects, the transmission and/or reception of signals by the UE may be implemented via a bus interface of one or more processors (e.g., controller/processor 280b) obtaining and/or outputting signals.

The operations 1100 may begin, at a first block 1102, by receiving, from a base station (BS), one or more parameters corresponding to a time period for a reconfigurable intelligent surface (RIS) to adapt to user equipment (UE) configuration information, the UE configuration information for configuring the RIS for RIS-assisted communication between the BS and the UE, the one or more parameters comprising a number of symbols indicative of a duration of time.

The operations 1100 may proceed to a second block 1104 by receiving, from the BS, a control channel scheduling communication of a data channel with the UE via the RIS.

The operations 1100 may proceed to a third block 1106 by communicating, via the RIS, the data channel with the BS the duration of time after receiving the control channel.

In certain aspects, the UE configuration information comprises a phase shift parameter configured to adjust a phase of one or more reflective elements of the RIS.

In certain aspects, receiving the one or more parameters comprises receiving a broadcast of the one or more parameters as system information via a synchronization signal block (SSB).

In certain aspects, the one or more parameters further comprise an indication of a reference subcarrier spacing (SCS) corresponding to the number of symbols.

In certain aspects, the indication of the reference SCS comprises one of: an indication that the reference SCS is the same as an SCS used for transmission of the control channel; an indication that the reference SCS is a fixed SCS; or an explicit indication of a frequency of the reference SCS.

In certain aspects, time resources for communicating the data channel are determined as a function of: (i) the number of symbols, and (ii) the reference SCS corresponding to the number of symbols.

In certain aspects, the control channel and the data channel are both transmitted within a first slot.

FIG. 12 is a flow diagram illustrating example operations 1200 for wireless communication, in accordance with certain aspects of the present disclosure. The operations 1200 may be performed, for example, by a RIS (e.g., such as the RIS 130 in the wireless communication network 100 of FIG. 1). The operations 1200 may be complementary to the operations 1000 of FIG. 10 performed by a BS, and operations 1100 of FIG. 11 performed by a UE. The operations 1200 may be implemented as software components that are executed and run on one or more processors (e.g., controller/processor 240 of FIG. 2). Further, the transmission and reception of signals by the RIS in operations 1200 may be enabled, for example, by one or more antennas (e.g., antennas 234a-234t of FIG. 2). In certain aspects, the transmission and/or reception of signals by the UE may be implemented via a bus interface of one or more processors (e.g., controller/processor 240) obtaining and/or outputting signals.

The operations 1200 may begin, at a first block 1202, by receiving, from a base station (BS), a control channel comprising user equipment (UE) configuration information, the UE configuration information for configuring the RIS for RIS-assisted communication between the BS and a UE, the control channel formatted according to a first format.

The operations 1200 may proceed at a second block 1204 by determining that the control channel is formatted according to the first format.

The operations 1200 may proceed at a third block 1206 by refraining from providing the control channel to the UE based on the determination that the control channel is formatted according to the first format.

Optionally, the operations 1200 may proceed at a fourth block 1208 by receiving, from the B S, a second control channel comprising one or more of additional UE configuration information or an assignment of one or more of uplink resources or downlink resources to the UE, the second control channel formatted according to a second format.

Optionally, the operations 1200 may proceed at a fifth block 1210 by determining that the second control channel is formatted according to the second format.

Optionally, the operations 1200 may proceed at a sixth block 1212 by providing the second control channel to the UE based on the determination that the second control channel is formatted according to the second format.

In certain aspects, the refraining from providing the control channel to the UE further comprises: determining a beam directed away from the UE; and transmitting a retransmission of the received control channel using the determined beam.

In certain aspects, the refraining from providing the control channel to the UE further comprises: generating a random retransmission configuration for one or more reflective elements of the RIS; and transmitting a retransmission of the received control channel according to the random retransmission configuration.

In certain aspects, the refraining from providing the control channel to the UE further comprises disabling one or more reflective elements of the RIS to prevent retransmission of the received control channel from the RIS to the UE.

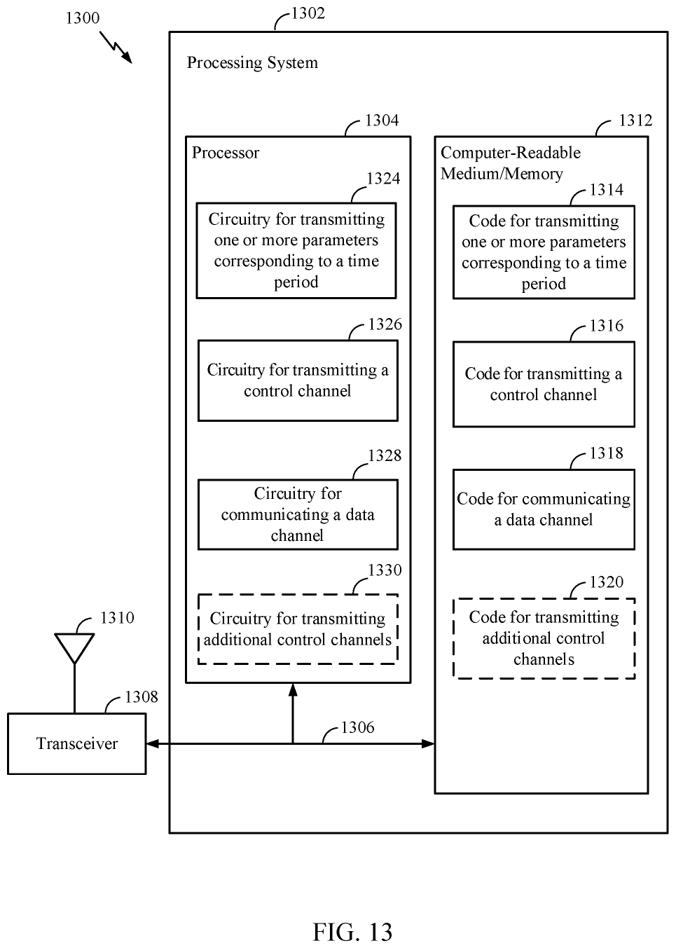

FIG. 13 illustrates a communications device 1300 that may include various components (e.g., corresponding to means-plus-function components) configured to perform operations for the techniques disclosed herein, such as the operations illustrated in FIG. 10. The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 10, or other operations for performing the various techniques discussed herein for configuring a RIS and communicating with a UE via the RIS.

In certain aspects, computer-readable medium/memory 1312 stores code 1314 for transmitting one or more parameters corresponding to a time period for a reconfigurable intelligent surface (RIS) to adapt to user equipment (UE) configuration information, the UE configuration information for configuring the RIS for RIS-assisted communication between the BS and a UE, the one or more parameters comprising a number of symbols indicative of a duration of time. The computer-readable medium/memory 1312 also stores code 1316 for transmitting, via the RIS and separately from transmitting the one or more parameters, a control channel to the UE scheduling communication of a data channel with the UE via the RIS. The computer-readable medium/memory 1312 also stores code 1318 for communicating, via the RIS, the data channel with the UE the duration of time after transmitting the control channel to the UE. Optionally, the computer-readable medium/memory 1312 also stores code 1320 for transmitting, to the RIS, another control channel comprising the UE configuration information.

In certain aspects, the processor 1304 includes circuitry 1324 for transmitting one or more parameters corresponding to a time period for a reconfigurable intelligent surface (RIS) to adapt to user equipment (UE) configuration information, the UE configuration information for configuring the RIS for RIS-assisted communication between the BS and a UE, the one or more parameters comprising a number of symbols indicative of a duration of time. In certain aspects, the processor 1304 includes circuitry 1326 for transmitting, via the RIS and separately from transmitting the one or more parameters, a control channel to the UE scheduling communication of a data channel with the UE via the RIS. In certain aspects, the processor 1304 includes circuitry 1328 for communicating, via the RIS, the data channel with the UE the duration of time after transmitting the control channel to the UE. In certain aspects, the processor 1304 includes circuitry 1330 for transmitting, to the RIS, another control channel comprising the UE configuration information.

For example, means for communicating (e.g., transmitting and receiving) or means for outputting for transmission and means for reception may include a transceiver(s) 254aa-254au and/or an antenna(s) 252aa-252au of the BS 110a illustrated in FIG. 2, and/or circuitry (1324, 1326, 1328, 1330) for transmitting and communicating of the communication device 1300 in FIG. 13.

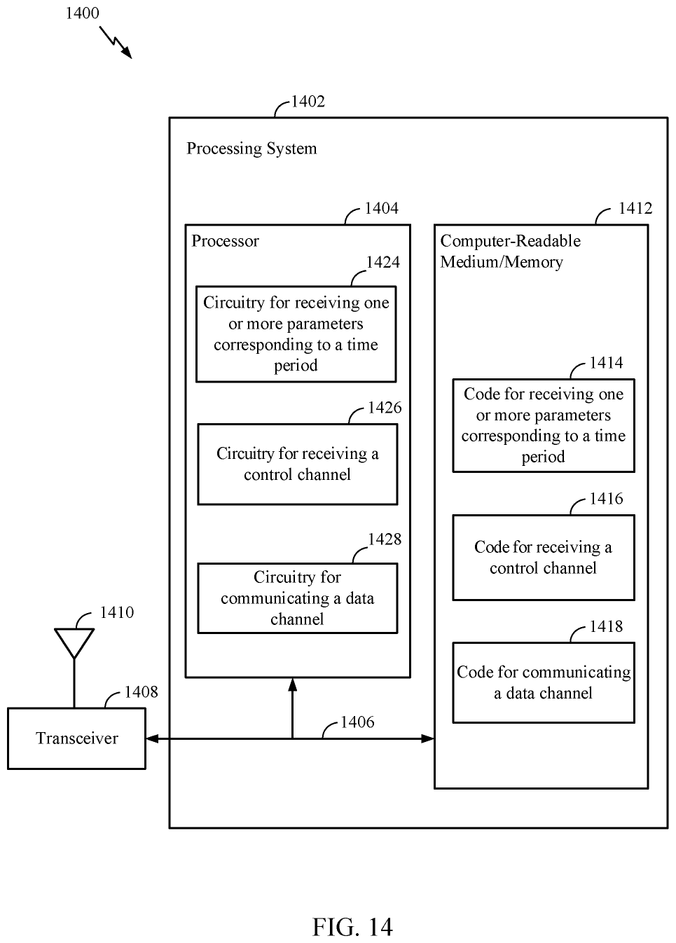

FIG. 14 illustrates a communications device 1400 that may include various components (e.g., corresponding to means-plus-function components) configured to perform operations for the techniques disclosed herein, such as the operations illustrated in FIG. 11. The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations illustrated in FIG. 11, or other operations for performing the various techniques discussed herein for configuring a RIS and communicating with a BS via the RIS.

In certain aspects, computer-readable medium/memory 1412 stores code 1414 for receiving, from a base station (BS), one or more parameters corresponding to a time period for a reconfigurable intelligent surface (RIS) to adapt to user equipment (UE) configuration information, the UE configuration information for configuring the RIS for RIS-assisted communication between the BS and the UE, the one or more parameters comprising a number of symbols indicative of a duration of time. The computer-readable medium/memory 1412 also stores code 1416 for receiving, from the B S, a control channel scheduling communication of a data channel with the UE via the RIS. The computer-readable medium/memory 1412 also stores code 1418 for communicating, via the RIS, the data channel with the BS the duration of time after receiving the control channel.

In certain aspects, the processor 1404 includes circuitry 1424 for receiving, from a base station (BS), one or more parameters corresponding to a time period for a reconfigurable intelligent surface (RIS) to adapt to user equipment (UE) configuration information, the UE configuration information for configuring the RIS for RIS-assisted communication between the BS and the UE, the one or more parameters comprising a number of symbols indicative of a duration of time. In certain aspects, the processor 1404 includes circuitry 1426 for receiving, from the BS, a control channel scheduling communication of a data channel with the UE via the RIS. In certain aspects, the processor 1404 includes circuitry 1428 for communicating, via the RIS, the data channel with the BS the duration of time after receiving the control channel.

For example, means for communicating (e.g., transmitting and receiving) or means for outputting for transmission and means for reception may include a transceiver(s) 254ba-254bu and/or an antenna(s) 252ba-252bu of the UE 120 illustrated in FIG. 2, and/or circuitry (1424, 1426, 1428) for receiving and communicating of the communication device 1300 in FIG. 14.

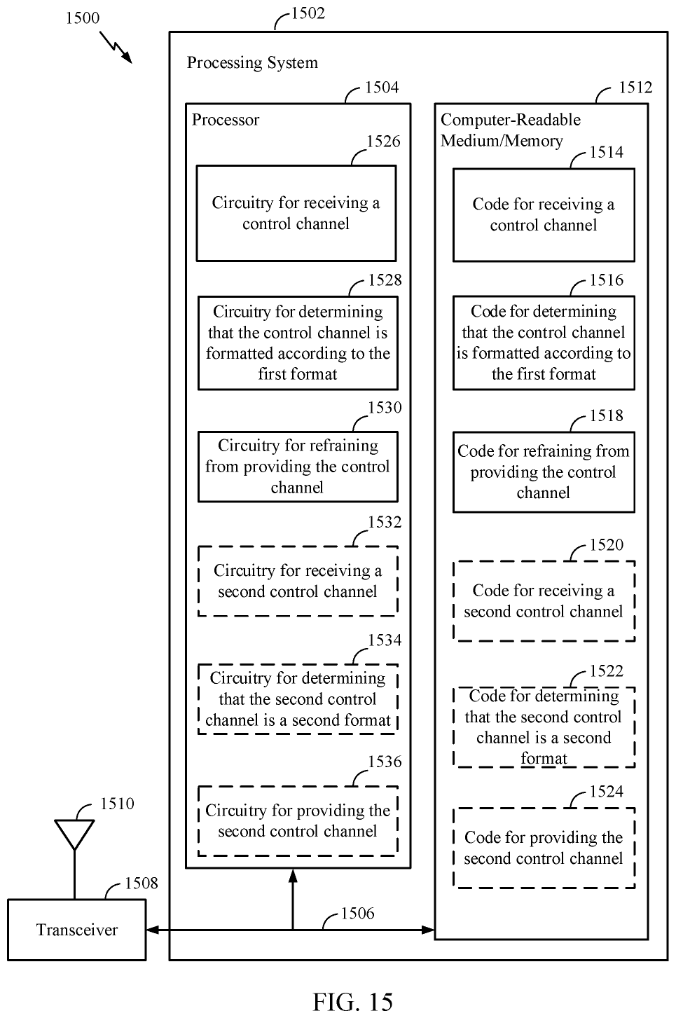

FIG. 15 illustrates a communications device 1500 that may include various components (e.g., corresponding to means-plus-function components) configured to perform operations for the techniques disclosed herein, such as the operations illustrated in FIG. 12. The communications device 1500 includes a processing system 1502 coupled to a transceiver 1508 (e.g., a transmitter and/or a receiver). The transceiver 1508 is configured to transmit and receive signals for the communications device 1500 via an antenna 1510, such as the various signals as described herein. The processing system 1502 may be configured to perform processing functions for the communications device 1500, including processing signals received and/or to be transmitted by the communications device 1500.

The processing system 1502 includes a processor 1504 coupled to a computer-readable medium/memory 1512 via a bus 1506. In certain aspects, the computer-readable medium/memory 1512 is configured to store instructions (e.g., computer-executable code) that when executed by the processor 1504, cause the processor 1504 to perform the operations illustrated in FIG. 12, or other operations for performing the various techniques discussed herein for configuring communication with a BS and a UE via a RIS.

In certain aspects, computer-readable medium/memory 1512 stores code 1514 for receiving, from a base station (BS), one or more parameters corresponding to a time period for a reconfigurable intelligent surface (RIS) to adapt to user equipment (UE) configuration information, the UE configuration information for configuring the RIS for RIS-assisted communication between the BS and the UE, the one or more parameters comprising a number of symbols indicative of a duration of time. The computer-readable medium/memory 1512 also stores code 1516 for determining that the control channel is formatted according to the first format. The computer-readable medium/memory 1512 also stores code 1518 for refraining from providing the control channel to the UE based on the determination that the control channel is formatted according to the first format. The computer-readable medium/memory 1512 also stores code 1520 for receiving, from the B S, a second control channel comprising one or more of additional UE configuration information or an assignment of one or more of uplink resources or downlink resources to the UE, the second control channel formatted according to a second format. The computer-readable medium/memory 1512 also stores code 1522 for determining that the second control channel is formatted according to the second format. The computer-readable medium/memory 1512 also stores code 1524 for providing the second control channel to the UE based on the determination that the second control channel is formatted according to the second format.

In certain aspects, the processor 1504 includes circuitry 1526 for receiving, from a base station (BS), a control channel comprising user equipment (UE) configuration information, the UE configuration information for configuring the RIS for RIS-assisted communication between the BS and a UE, the control channel formatted according to a first format. In certain aspects, the processor 1504 includes circuitry 1528 for determining that the control channel is formatted according to the first format. In certain aspects, the processor 1504 includes circuitry 1530 for refraining from providing the control channel to the UE based on the determination that the control channel is formatted according to the first format. In certain aspects, the processor 1504 includes circuitry 1532 for receiving, from the B S, a second control channel comprising one or more of additional UE configuration information or an assignment of one or more of uplink resources or downlink resources to the UE, the second control channel formatted according to a second format. In certain aspects, the processor 1504 includes circuitry 1534 for determining that the second control channel is formatted according to the second format. In certain aspects, the processor 1504 includes circuitry 1536 for providing the second control channel to the UE based on the determination that the second control channel is formatted according to the second format.

For example, means for receiving and providing (e.g., receiving and reflecting or forwarding) may include a transceiver(s) 232a-232t and/or an antenna(s) 234a-234t of the RIS 130 illustrated in FIG. 2, and/or circuitry (1526, 1532, 1536) for receiving and providing of the communication device 1500 in FIG. 15. In another example, means for determining and refraining may include a controller/processor 240 of the RIS 130 illustrated in FIG. 2, and/or circuitry (1528, 1530, 1534) for determining and refraining of the communication device 1500 in FIG. 15.

### Example Aspects

Implementation examples are described in the following numbered clauses:
Aspect 1: A method of wireless communication by a base station (BS), the method comprising: transmitting one or more parameters corresponding to a time period for a reconfigurable intelligent surface (RIS) to adapt to user equipment (UE) configuration information, the UE configuration information for configuring the RIS for RIS-assisted communication between the BS and a UE, the one or more parameters comprising a number of symbols indicative of a duration of time; transmitting, via the RIS and separately from transmitting the one or more parameters, a control channel to the UE scheduling communication of a data channel with the UE via the RIS; and communicating, via the RIS, the data channel with the UE the duration of time after transmitting the control channel to the UE.
Aspect 2: The method of aspect 1, wherein the UE configuration information comprises a phase shift parameter configured to adjust a phase of one or more reflective elements of the RIS.
Aspect 3: The method of any of aspects 1 and 2, wherein transmitting the one or more parameters comprises broadcasting the one or more parameters as system information via a synchronization signal block (SSB).
Aspect 4: The method of any of aspects 1-3, wherein the one or more parameters further comprise an indication of a reference subcarrier spacing (SCS) corresponding to the number of symbols.
Aspect 5: The method of any of aspects 1-4, wherein the indication of the reference SCS comprises one of: an indication that the reference SCS is the same as an SCS used for transmission of the control channel; an indication that the reference SCS is a fixed SCS; or an explicit indication of a frequency of the reference SCS.
Aspect 6: The method of any of aspects 1-5, wherein the control channel and the data channel are both transmitted within a first slot.
Aspect 7: The method of any of aspects 1-6, wherein the control channel comprises the UE configuration information.
Aspect 8: The method of any of aspects 1-7, further comprising transmitting, to the RIS, another control channel comprising additional UE configuration information.
Aspect 9: The method of any of aspects 1-8, wherein the control channel comprises a first downlink control information (DCI) message formatted according to a first DCI format and comprising a first radio network temporary identifier (RNTI), and wherein the other control channel comprises a second DCI message formatted according to a second DCI format and comprising a second RNTI, the second RNTI corresponding to the UE and the first RNTI not corresponding to the UE.
Aspect 10: A method of wireless communication by a user equipment (UE), the method comprising: receiving, from a base station (BS), one or more parameters corresponding to a time period for a reconfigurable intelligent surface (RIS) to adapt to user equipment (UE) configuration information, the UE configuration information for configuring the RIS for RIS-assisted communication between the BS and the UE, the one or more parameters comprising a number of symbols indicative of a duration of time; receiving, from the BS, a control channel scheduling communication of a data channel with the UE via the RIS; and communicating, via the RIS, the data channel with the BS the duration of time after receiving the control channel.
Aspect 11: The method of aspect 10, wherein the UE configuration information comprises a phase shift parameter configured to adjust a phase of one or more reflective elements of the RIS.
Aspect 12: The method of any of aspects 10 and 11, wherein receiving the one or more parameters comprises receiving a broadcast of the one or more parameters as system information via a synchronization signal block (SSB).
Aspect 13: The method of any of aspects 10-12, wherein the one or more parameters further comprise an indication of a reference subcarrier spacing (SCS) corresponding to the number of symbols.
Aspect 14: The method of any of aspects 10-13, wherein the indication of the reference SCS comprises one of: an indication that the reference SCS is the same as an SCS used for transmission of the control channel; an indication that the reference SCS is a fixed SCS; or an explicit indication of a frequency of the reference SCS.
Aspect 15: The method of any of aspects 10-14, wherein time resources for communicating the data channel are determined as a function of: (i) the number of symbols, and (ii) the reference SCS corresponding to the number of symbols.
Aspect 16: The method of any of aspects 10-15, wherein the control channel and the data channel are both transmitted within a first slot.
Aspect 17: A method of wireless communication by a reconfigurable intelligent surface (RIS), the method comprising: receiving, from a base station (BS), a control channel comprising user equipment (UE) configuration information, the UE configuration information for configuring the RIS for RIS-assisted communication between the BS and a UE, the control channel formatted according to a first format; determining that the control channel is formatted according to the first format; and refraining from providing the control channel to the UE based on the determination that the control channel is formatted according to the first format.
Aspect 18: The method of aspect 17, further comprising: receiving, from the BS, a second control channel comprising one or more of additional UE configuration information or an assignment of one or more of uplink resources or downlink resources to the UE, the second control channel formatted according to a second format; determining that the second control channel is formatted according to the second format; and providing the second control channel to the UE based on the determination that the second control channel is formatted according to the second format.
Aspect 19: The method of any of aspects 17 and 18, wherein the refraining from providing the control channel to the UE further comprises: determining a beam directed away from the UE; and transmitting a retransmission of the received control channel using the determined beam.
Aspect 20: The method of any of aspects 17-19, wherein the refraining from providing the control channel to the UE further comprises: generating a random retransmission configuration for one or more reflective elements of the RIS; and transmitting a retransmission of the received control channel according to the random retransmission configuration.
Aspect 21: The method of any of aspects 17-20, wherein the refraining from providing the control channel to the UE further comprises disabling one or more reflective elements of the RIS to prevent retransmission of the received control channel from the RIS to the UE.
Aspect 22: A base station (BS), comprising: a memory; and a processor coupled to the memory, the processor and the memory configured to: transmit one or more parameters corresponding to a time period for a reconfigurable intelligent surface (RIS) to adapt to user equipment (UE) configuration information, the UE configuration information for configuring the RIS for RIS-assisted communication between the BS and a UE, the one or more parameters comprising a number of symbols indicative of a duration of time; transmit, via the RIS and separately from transmitting the one or more parameters, a control channel to the UE scheduling communication of a data channel with the UE via the RIS; and communicate, via the RIS, the data channel with the UE the duration of time after transmitting the control channel to the UE.
Aspect 23: The BS of aspect 22, wherein the UE configuration information comprises a phase shift parameter configured to adjust a phase of one or more reflective elements of the RIS.
Aspect 24: The BS of any of aspects 22 and 23, wherein transmitting the one or more parameters comprises broadcasting the one or more parameters as system information via a synchronization signal block (SSB).
Aspect 25: The BS of any of aspects 22-24, wherein the one or more parameters further comprise an indication of a reference subcarrier spacing (SCS) corresponding to the number of symbols.
Aspect 26: The BS of any of aspects 22-25, wherein the indication of the reference SCS comprises one of: an indication that the reference SCS is the same as an SCS used for transmission of the control channel; an indication that the reference SCS is a fixed SCS; or an explicit indication of a frequency of the reference SCS.
Aspect 27: The BS of any of aspects 22-26, wherein the control channel and the data channel are both transmitted within a first slot.
Aspect 28: The BS of any of aspects 22-27, wherein the control channel comprises the UE configuration information.
Aspect 29: The BS of any of aspects 22-28, further comprising transmitting, to the RIS, another control channel comprising additional UE configuration information.
Aspect 30: The BS of any of aspects 22-29, wherein the control channel comprises a first downlink control information (DCI) message formatted according to a first DCI format and comprising a first radio network temporary identifier (RNTI), and wherein the other control channel comprises a second DCI message formatted according to a second DCI format and comprising a second RNTI, the second RNTI corresponding to the UE and the first RNTI not corresponding to the UE.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. CdMA2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. ABS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another. In other words, unless a specific order of steps or actions is specified, the order and/or use of specific steps and/or actions may be modified.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor). Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of a physical (PHY) layer. In the case of a user terminal or user equipment (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above can also be considered as examples of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 10, FIG. 11, and/or FIG. 12.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above.

1. A method of wireless communication by a base station (BS), the method comprising:
transmitting one or more parameters corresponding to a time period for a reconfigurable intelligent surface (RIS) to adapt to user equipment (UE) configuration information, the UE configuration information for configuring the RIS for RIS-assisted communication between the BS and a UE, the one or more parameters comprising a number of symbols indicative of a duration of time;
transmitting, via the RIS and separately from transmitting the one or more parameters, a control channel to the UE scheduling communication of a data channel with the UE via the RIS; and
communicating, via the RIS, the data channel with the UE the duration of time after transmitting the control channel to the UE.

2. The method of claim 1, wherein the UE configuration information comprises a phase shift parameter configured to adjust a phase of one or more reflective elements of the RIS.

3. The method of claim 1, wherein transmitting the one or more parameters comprises broadcasting the one or more parameters as system information via a synchronization signal block (SSB).

4. The method of claim 1, wherein the one or more parameters further comprise an indication of a reference subcarrier spacing (SCS) corresponding to the number of symbols.

5. The method of claim 4, wherein the indication of the reference SCS comprises one of:
an indication that the reference SCS is the same as an SCS used for transmission of the control channel;
an indication that the reference SCS is a fixed SCS; or
an explicit indication of a frequency of the reference SCS.

6. The method of claim 1, wherein the control channel and the data channel are both transmitted within a first slot.

7. The method of claim 1, wherein the control channel comprises the UE configuration information.

8. The method of claim 1, further comprising transmitting, to the RIS, another control channel comprising additional UE configuration information.

9. The method of claim 8, wherein the control channel comprises a first downlink control information (DCI) message formatted according to a first DCI format and comprising a first radio network temporary identifier (RNTI), and wherein the other control channel comprises a second DCI message formatted according to a second DCI format and comprising a second RNTI, the second RNTI corresponding to the UE and the first RNTI not corresponding to the UE.

10. A method of wireless communication by a user equipment (UE), the method comprising:
receiving, from a base station (BS), one or more parameters corresponding to a time period for a reconfigurable intelligent surface (RIS) to adapt to user equipment (UE) configuration information, the UE configuration information for configuring the RIS for RIS-assisted communication between the BS and the UE, the one or more parameters comprising a number of symbols indicative of a duration of time;
receiving, from the BS, a control channel scheduling communication of a data channel with the UE via the RIS; and
communicating, via the RIS, the data channel with the BS the duration of time after receiving the control channel.

11. The method of claim 10, wherein the UE configuration information comprises a phase shift parameter configured to adjust a phase of one or more reflective elements of the RIS.

12. The method of claim 10, wherein receiving the one or more parameters comprises receiving a broadcast of the one or more parameters as system information via a synchronization signal block (SSB).

13. The method of claim 10, wherein the one or more parameters further comprise an indication of a reference subcarrier spacing (SCS) corresponding to the number of symbols.

14. The method of claim 13, wherein the indication of the reference SCS comprises one of:
an indication that the reference SCS is the same as an SCS used for transmission of the control channel;
an indication that the reference SCS is a fixed SCS; or
an explicit indication of a frequency of the reference SCS.

15. The method of claim 13, wherein time resources for communicating the data channel are determined as a function of: (i) the number of symbols, and (ii) the reference SCS corresponding to the number of symbols.

16. The method of claim 10, wherein the control channel and the data channel are both transmitted within a first slot.

17. A method of wireless communication by a reconfigurable intelligent surface (RIS), the method comprising:
receiving, from a base station (BS), a control channel comprising user equipment (UE) configuration information, the UE configuration information for configuring the RIS for RIS-assisted communication between the BS and a UE, the control channel formatted according to a first format;
determining that the control channel is formatted according to the first format; and refraining from providing the control channel to the UE based on the determination that the control channel is formatted according to the first format.

18. The method of claim 17, further comprising:
receiving, from the BS, a second control channel comprising one or more of additional UE configuration information or an assignment of one or more of uplink resources or downlink resources to the UE, the second control channel formatted according to a second format;
determining that the second control channel is formatted according to the second format; and
providing the second control channel to the UE based on the determination that the second control channel is formatted according to the second format.

19. The method of claim 17, wherein the refraining from providing the control channel to the UE further comprises:
determining a beam directed away from the UE; and
transmitting a retransmission of the received control channel using the determined beam.

20. The method of claim 17, wherein the refraining from providing the control channel to the UE further comprises:
generating a random retransmission configuration for one or more reflective elements of the RIS; and
transmitting a retransmission of the received control channel according to the random retransmission configuration.

21. The method of claim 17, wherein the refraining from providing the control channel to the UE further comprises disabling one or more reflective elements of the RIS to prevent retransmission of the received control channel from the RIS to the UE.

22. Abase station (BS), comprising:
a memory; and
a processor coupled to the memory, the processor and the memory configured to:
transmit one or more parameters corresponding to a time period for a reconfigurable intelligent surface (RIS) to adapt to user equipment (UE) configuration information, the UE configuration information for configuring the RIS for RIS-assisted communication between the BS and a UE, the one or more parameters comprising a number of symbols indicative of a duration of time;
transmit, via the RIS and separately from transmitting the one or more parameters, a control channel to the UE scheduling communication of a data channel with the UE via the RIS; and communicate, via the RIS, the data channel with the UE the duration of time after transmitting the control channel to the UE.

23. The BS of claim 22, wherein the UE configuration information comprises a phase shift parameter configured to adjust a phase of one or more reflective elements of the RIS.

24. The BS of claim 22, wherein transmitting the one or more parameters comprises broadcasting the one or more parameters as system information via a synchronization signal block (SSB).

25. The BS of claim 22, wherein the one or more parameters further comprise an indication of a reference subcarrier spacing (SCS) corresponding to the number of symbols.

26. The BS of claim 25, wherein the indication of the reference SCS comprises one of:
an indication that the reference SCS is the same as an SCS used for transmission of the control channel;
an indication that the reference SCS is a fixed SCS; or
an explicit indication of a frequency of the reference SCS.

27. The BS of claim 22, wherein the control channel and the data channel are both transmitted within a first slot.

28. The BS of claim 22, wherein the control channel comprises the UE configuration information.

29. The BS of claim 22, further comprising transmitting, to the RIS, another control channel comprising additional UE configuration information.

30. The BS of claim 29, wherein the control channel comprises a first downlink control information (DCI) message formatted according to a first DCI format and comprising a first radio network temporary identifier (RNTI), and wherein the other control channel comprises a second DCI message formatted according to a second DCI format and comprising a second RNTI, the second RNTI corresponding to the UE and the first RNTI not corresponding to the UE.
